(19) United States
(12) Patent Application Publication
(10) Pub. No.: US 2017/0183257 A1
(43) Pub. Date: Jun. 29, 2017

(54) METHOD FOR PRODUCTION OF A COATED, CHEMICALLY PRESTRESSED GLASS SUBSTRATE HAVING ANTI-FINGERPRINT PROPERTIES AND PRODUCED GLASS SUBSTRATE

(71) Applicant: Schott AG, Mainz (DE)

(72) Inventors: Dirk Apitz, Lausanne (CH); Marta Krzyzak, Bad Gandersheim (DE); Marten Walther, Alfeld (DE); Jochen Alkemper, Klein-Winternheim (DE)

(73) Assignee: Schott AG, Mainz (DE)

(21) Appl. No.: 15/455,325

(22) Filed: Mar. 10, 2017

Related U.S. Application Data
(63) Continuation of application No. PCT/EP2015/067008, filed on Jul. 24, 2015.

(30) Foreign Application Priority Data
Sep. 12, 2014 (DE) 10 2014 013 527.6

(51) Int. Cl. C03C 17/42; C03C 17/30; C03C 17/32; C03C 17/34; C03C 23/00; C03C 3/112; C03C 3/118; C03C 3/097; C03C 3/091; C03C 3/093; C03C 3/083; C03C 3/085; C03C 3/087; C03C 3/095; C03C 3/102; C03C 3/108; C03C 3/105; C03C 3/07; C03C 3/072; C03C 3/074; C03C 10/00; C03C 21/00

(52) U.S. Cl. CPC C03C 17/42; C03C 21/002; C03C 17/30; C03C 17/32; C03C 17/3411; C03C 23/006; C03C 23/0075; C03C 3/112; C03C 3/118; C03C 3/097; C03C 3/091; C03C 3/093; C03C 3/083; C03C 3/085; C03C 3/087; C03C 3/095; C03C 3/102; C03C 3/108; C03C 3/105; C03C 3/07; C03C 3/072; C03C 3/074; C03C 3/0745; C03C 10/0027; C03C 10/0054; C03C 2217/241; C03C 2217/73; C03C 2217/76; C03C 2217/78

(57) ABSTRACT

The invention relates to a method for producing a coated, chemically prestressed glass substrate having anti-fingerprint properties. The method includes: applying at least one functional layer to a glass substrate; chemically prestressing the coated glass substrate by an ion exchange, where existing smaller alkali metal ions are exchanged for larger alkali metal ions, and are enriched in the glass substrate and the at least one functional layer; activating the surface of the at least one functional layer, where if more than one functional layer is present the surface of the outermost or uppermost layer is activated, the activating including one of several alternatives; and applying an amphiphobic coating to the at least one functional layer of the glass substrate, where, as a result of the activation process, the functional layer interacts with the amphiphobic coating.

### CROSS REFERENCE TO RELATED APPLICATIONS

This is a continuation of PCT application No. PCT/EP2015/067008, entitled “METHOD FOR PRODUCTION OF A COATED, CHEMICALLY PRESTRESSED GLASS SUBSTARATE HAVING ANTI-FINGERPRINT PROPERTIES; AS WELL AS THE PRODUCED GLASS SUBSTRATE”, filed Jul. 24, 2015, which is incorporated herein by reference.

### BACKGROUND OF THE INVENTION

1. Field of the Invention

The invention relates to a method for production of a coated, chemically prestressed glass substrate with anti-fingerprint properties, as well as the produced glass substrate.

2. Description of the Related Art

The strong growing market for touch or sensor screens, for example in the field of touch panel applications with interactive input, leads to ever higher expectations in the multi-touch applications sector. Touch screens are used, for example, to operate smart phones, ATMs, informational monitors, such as at railway stations, slot machines or for control of machines in the industrial sector. There is a special interest for mobile products, for example notebooks, laptop computers, watches, mobile telephones or navigation devices. Additional fields of application where touching of glass or glass ceramic surfaces for operation or use play a role are in refrigeration or cooking appliances, for example glass ceramic cooktops and induction cooktops, shop windows, counters or show cases. In all these uses, good and hygienic functionality without high cleaning effort and good transparency with a high aesthetic effect are of paramount importance and are impaired by dirt and pressure marks of fingerprints.

One problem in such applications is to maintain the transparent appearance, whereby oils and fats that transfer to the surface through fingerprints are difficult to remove. The difficulty in removing oils and fats from transparent surfaces is especially important in touch applications such as touch screens where fingerprints are repeatedly put on the cover glass surface during use of the device. Fingerprints, caused by fingerprint oil and fats, cosmetics residues, for example from hand lotions and the like, and dirt from other sources appear on the screen such as in the case of a dark or black background—for example when the device is not being used. Fingerprints and dirt also lead to problems in regard to interference and negatively affect the image quality.

An additional problem in such applications is the gloss that can stem from reflections on the screen surface. Glossiness is the optical characteristic of a surface to reflect light completely or partially and occurs on reflection of light that is not vertical/perpendicular to the visual field of the user. The presence of glossiness causes the user to have to change the positioning of the device, such as having to tip or tilt the device to change the screen angle for a better view. A permanent change in the position of the device is inconvenient and unsatisfactory for the user. The gloss of a display surface moreover makes the fingerprints more visible, since gloss tipping emphasizes the fingerprints on the surface. The requirement for an ‘anti-fingerprint” or “easy-to-clean” coating for antireflective surfaces is thus of even greater importance.

Anti-fingerprint coating ensures that the fingerprints and dirt that get onto the surface are easy to remove and that the contaminations—in particular fingerprints—are at least no longer visible and that the user surface appears clean even without having been cleaned. An anti-fingerprint coating can also be an easy-to-clean coating whereby the transitions here are partially fluent. The touch surface must be resistant relative to water, salt and fat deposits that appear, for example, from residues of fingerprints during use by the operator. The characteristics of the surface are such that the surface is simultaneously water repellant (hydrophobic) and oil repellant (oleophobic). Such layers are therefore also referred to as amphiphobic layers.

In addition to the high dirt repelling, easy-clean features and scratch and abrasion resistance, for example, when using input styluses, and resistance against chemical stresses due to salts and fat-containing finger sweat, the durability of the coating, especially the long-term durability after use and many cleaning cycles, is important.

Numerous suggestions for anti-fingerprint coating are known.

DE 198 48 591 A1 describes loading of an optical screen with a fluoro-organic compound. Hydrocarbon residue that is partially fluorinated or chloro-fluorinated is accumulated selectively via a polar group at an imperfection on the surface of the optical screen that is produced from a metallic material or is covered by a metallic coating, thus providing a highly effective protective layer. The suggestion is suitable for all optical screens in the form of tinted of fully transparent panels or lenses, and reflective or mirrored screens. One effective field of application is for windshields and headlamp lenses on motor vehicles.

EP 0 844 265 A1 moreover describes a silicon containing organic fluoropolymers for coating of substrate surfaces, such as metallic glass and plastic material, to provide the surface with sufficient and long-term anti-fingerprint properties, sufficient weather resistance, slippage, anti-adhesion properties, water repelling properties and resistance against oily contaminants and fingerprints.

US 2010/0279068 A1 describes a fluoropolymer of fluorosilanes as an anti-fingerprint coating. To improve the surface properties for anti-fingerprint coating, a structure is embossed into the surface of the glass object, or particles are pressed into same. This process is, however, time consuming and costly and, due to the necessary thermal processes, causes undesirable stresses in the glass objects.

US 2010/0285272 A1 describes a glass substrate whose surface possesses hydrophobic, oleophobic, anti-adhesion and anti-fingerprint properties in that a certain topology is applied onto the surface, for example by roughening or provision of a pattern.

US 2009/0197048 A1 describes an anti-fingerprint or easy-to-clean coating on a cover glass in the form of an outside coating with fluorine end groups such as perfluorocarbon or a perfluorocarbon containing residue, that provide the cover glass with a level of hydrophobicity and oleophobicity, so that moistening of the glass surface with water and oil is minimized. To apply this layer onto a glass surface, it is suggested to temper the surface by chemical ion exchange, in that especially potassium ions instead of sodium and/or lithium ions are embedded. The cover glass may moreover include an antireflective layer underneath the anti-fingerprint or easy-to-clean coating, consisting of silicon dioxide, quartz glass, fluorine doped silicon dioxide, fluorine doped quartz glass, MgF₂, HfO₂, TiO₂, ZrO₂, Y₂O₃ or Gd₂O₃. It is also suggested to produce a texture or pattern on the glass surface prior to application of the anti-fingerprint coating by etching, lithography or particle coating. After tempering by ion exchange and prior to anti-fingerprint coating the glass surface can be subjected to an acid treatment. These efforts are also time consuming and do not result in a coating that is sufficient for the entirety of the required properties.

Even though a variety of coatings are known which offer a degree of surface protection to minimize adhesion of fingerprints, and possess oil and water repellent characteristics, these coatings for chemically prestressed glasses for touchscreen applications have, to date, not led to satisfactory results. One particular problem with known anti-fingerprint coatings is the limited long-term durability of the layers, so that a rapid decrease of the properties can be observed in the case of chemical and physical assaults. This detriment is not only dependent on the type of coating, but also on the type of substrate surface onto which it is applied.

It is moreover generally known to pre-stress glass chemically or thermally to increase the strength of the glass. A clear increase of the breaking- and scratch resistance can hereby be achieved in contrast to a similar glass that is not prestressed. Chemical pre-stressing or tempering is based in that a smaller ion present in the glass is exchanged on the surface with a larger ion. Due to the greater space requirement of these larger ions, a compressive stress occurs in the surface. The ion exchange occurs normally in a sodium- and/or lithium containing glass in a potassium-containing medium, so that the sodium- and/or lithium ions of the glass in the surface-near regions are exchanged at least partially by potassium ions. In place of potassium ions, other ions such as Cs and/or Rb ions may also be used.

During thermal pre-stressing, the compressive stress occurs through rapid cooling of the glass. However, thin glasses cannot practically be thermally prestressed, since a sufficient temperature gradient cannot be reached in the glass. Moreover, thermally prestressed glasses cannot be cut. Chemical pre-stressing is therefore preferably used.

Chemical pre-stressing is known from many publications. Examples are DE 10 2007 009 786 A1 as well as DE 10 2007 009 785 A1, where the basic method for chemical pre-stressing of a glass pane is described.

From the foregoing, it can be appreciated that the durability of an amphiphobic or anti-fingerprint coating is clearly reduced by chemical pre-stressing. This is reflected, for example, in shorter durability in relevant tests, such as the neutral salt spray test which is described in detail for example in WO 2012/163946 and WO 2012/163947.

What is needed in the art is a glass substrate which overcomes some of the disadvantages previously described and that is chemically prestressed and has an amphiphobic coating that possesses sufficient long-term durability. Moreover, a method to produce such a coated and chemically prestressed glass substrate is needed.

### SUMMARY OF THE INVENTION

The present invention provides a glass substrate which solves some of the previously described problems in a surprising manner, wherein chemical pre-stressing of the glass substrate in the form of an ion exchange is conducted through all layers that are disposed on the glass and the functionality-coating that is present on the glass substrate is then activated, after which the amphiphobic coating that acts as an anti-fingerprint coating is applied.

The present invention in one embodiment relates to a method for producing a coated, chemically prestressed glass substrate having anti-fingerprint properties. The method includes:
application of at least one functional layer onto a glass substrate,
chemical pre-stressing of the coated glass substrate by an ion exchange, whereby existing smaller alkali metal ions are exchanged for larger alkali metal ions and are enriched in the glass substrate and the at least one functional layer,
activating the surface of the at least one functional layer, whereby if more than one functional layer is present, the surface of the outermost or uppermost layer is activated and the activation of the surface of the at least one functional layer is conducted by using one of the following alternatives:
   (1) treating the surface with alkaline aqueous solution, which can have a pH>9, and subsequent washing with water, such as deionized or demineralized water;
   (2) treating the surface with an acidic aqueous solution, which can have a pH<6 and subsequent washing with water, such as deionized or demineralized water;
   (3) treating the surface with alkaline aqueous solution, which can have a pH>9, followed by treating the surface with an acidic aqueous solution, which can have a pH<6 and subsequent washing with water, such as deionized or demineralized water;
   (4) washing the surface with an aqueous washing solution containing one or several tensides, then rinsing with water, such as deionized or demineralized water;
   (5) washing the surface with water, such as deionized or demineralized water;
   (6) alternative 1), alternative 2), alternative 3) or alternative 4), respectively, combined with ultrasonic cleaning;
   (7) treating the surface with oxygen-plasma; and
   (8) alternative 1), alternative 2), alternative 3) alternative 4), alternative 5) or alternative 6), respectively, combined with oxygen-plasma treatment;
      and
Application of an amphiphobic coating onto the at least one functional layer of the glass substrate, whereby as a result of the activation process, the functional layer interacts with the amphiphobic coating.

As a result of the activation process, the existing functional coating possesses the characteristic of being able to better interact with an amphiphobic coating that is to be applied, so that the amphiphobic coating offers higher long-term stability.

Interaction in the current case is a chemical, in particular a covalent, bond between the functional layer of the substrate and an amphiphobic coating that is to be applied later that acts so that its long-term resistance is increased.

Within the scope of the present invention, “amphiphobic coating” is understood to be a coating that has high dirt-repelling properties, is easy to clean and has an anti-graffiti effect. The material surface of such an amphiphobic coating has a resistance against deposits, for example, from fingerprints, such as liquid, salts, fats, dirt and other substances. This relates to the chemical resistance relative to such deposits, as well as to a low wettability behavior relative to such deposits. It moreover relates to the suppression, avoidance or reduction of fingerprint appearance due to touching by a user. Fingerprints contain mainly salts, amino acids and fats, substances such as talcum, sweat, residues of dead skin cells, cosmetics and lotions and, possibly, dirt in the form of liquid and particles of various types.

Such an amphiphobic coating must therefore be resistant against water with salt, as well as against fat and oil deposits and must have a low wettability behavior relative to both. Special attention can be paid to a high resistance in a saltwater spray test. The wettability characteristic of a surface with an amphiphobic coating must be such that that the surface is hydrophobic, meaning that the contact angle between the surface and water is greater than 90°; as well as oleophobic, meaning that the contact angle between surface and oil is greater than 50°.

One exemplary embodiment of the present invention provide a coated, chemically prestressed glass substrate that is produced with one or more methods according to the present invention and which possesses anti-fingerprint properties.

In a surprising manner, it has become evident that activating an already coated glass substrate that was previously chemically prestressed together with the coating results in a clearly higher long-term durability of the amphiphobic coating applied thereupon.

The coated, chemically prestressed glass substrate that is produced according to the present invention moreover has increased scratch resistance compared to a coated glass that was not chemically prestressed, is abrasion resistant and resistant generally to damage. Coated glass generally has lower scratch resistance values than uncoated glass, with the exception of special scratch resistant coatings. Because of chemical pre-stressing of the coated glass, the breaking strength and scratch resistance are now increased, whereby the residual porosity existing in the coating can be responsible for a somewhat lower scratch resistance than in an uncoated glass.

The glass substrate with the amphiphobic coating additionally possesses anti-fingerprint and dirt repelling characteristics which are imparted by the amphiphobic surface layer that keep the transfer of fats/oils from fingermarks to the glass in the form of fingerprints to a minimum and which moreover makes possible an easy removal of the fats/oils from the fingerprints through wiping with a cloth.

The individual aspects of exemplary embodiments according to the present invention are discussed below in detail:

Description of the Glass Substrate

The glass subject is initially provided with at least one functional layer. Such a functional layer can be composed of one or several layers. According to the invention “functional layer(s)” is/are understood to be one or more layer(s) that provide the glass substrate with one or several properties for the intended use. The glass substrate can have one or several functional layers on one or on both sides.

For simplification, reference is frequently made herein to only one “functional layer”; embodiments having more than one layer—if not stated otherwise—are understood to be included herewith.

The functional layer(s) that are present on the glass substrate can be selected so that the influence of the composition, thickness and structure of the functional layer(s) are such that they are not impaired by the conditions of chemical pre-stressing, that the ion exchange can occur and that the ion exchange time can be realized in practice.

A functional layer or the outermost or uppermost layer of the functional layers can be selected so that it can interact with the amphiphobic coating.

To meet the above prerequisites, the functional layers, especially the outermost or uppermost functional layer, can be selected so that they are composed of inorganic materials.

It has proven to be useful if the functional layer, in particular the uppermost functional layer, includes or consists of one or more Si-compounds, such as one or more silicon oxide compounds. The Si-compound can be selected, for example, from a silicon oxide. The silicon oxide can be SiOₓ with x being less or equal 2, SiOC, SiON, SiOCN and Si₃N₄, as well as hydrogen that can be combined in any volume with SiOₓ, with x being less or equal 2, SiOC, SiON and SiOCN.

In one exemplary embodiment, the functional layer, such as the uppermost functional layer, is a silicon mixed oxide layer.

In the context of this invention, “silicon oxide” is understood to be any silicon oxide between silicon mono- and silicon dioxide and silicon is understood to be a metal and a metalloid. Further within the context of the present invention, silicon mixed oxide is a mixture of a silicon oxide and an oxide of at least one of the other elements that can be homogeneous or non-homogeneous, stoichiometric or non-stoichiometric. A silicon mixed oxide can include an oxide of at least one of the following elements: aluminum, tin, magnesium, phosphorus, cerium, zircon, titanium, cesium, barium, strontium, niobium, zinc, boron and/or magnesium fluoride, whereby at least one oxide of the aluminum element can be contained with up to 90 weight-%.

The functional layer(s) can basically be applied with any coating method with which homogeneous layers can be applied over large areas.

According to the present invention, functional layers can, for example, be selected from optically effective layers such as antireflective-, antiglare-, antidazzle layers, anti-scratch layers, conductive layers, cover layers, adhesion promoting layers, protective layers such as corrosion protective layers, abrasion resistant layers, photocatalytic layers, antimicrobial layers, decorative layers, such as colored SiO₂ layers, electrochromic layers and all other layers that provide the glass substrate with a function and are known.

Also, one or more very thin intermediate layers may be provided that do not impair the intended function, or impair it only insignificantly. These intermediate layers serve predominantly to avoid stress within a layer. For example, one or several silicon oxide intermediate layers may be present.

The entire layer package in the form of the functional layer can consist of one or at least two layers, wherein it is sufficient for the long-term stability if the uppermost layer after chemical pre-stressing and activation of the surface interacts with the amphiphobic layer.

One functional coating that can be provided according to the present invention is a coating comprising one or several antireflective layers which serve to reduce the reflectivity of the glass surface and to increase the transmission.

According to the present invention, two antireflective coating as a possible functional layer is not limited; any antireflective coating known to the expert may be used. The antireflective coating can be of any desired design and may consist of one or several layers and possibly comprises one or several optically non-active intermediate layers, for example multi-layer systems consisting of high-refractive and low-refractive layers, or medium-refractive, high-refractive and low-refractive layer-systems.

If the antireflective coating represents a single layer, then the coating material can be, for example, a metal oxide, fluorine doped metal oxide and/or metal fluoride. An SiO₂-containing layer can be a fluorine doped SiO₂, fluorine doped quartz glass, an SiO₂—TiO₂ layer with photocatalytic properties or magnesium fluoride silicon oxide or silicon mixed oxide. Other metal oxides and/or metal fluorides that are known in the art as antireflective coatings are also possible.

The Sol-Gel layer can also be a porous Sol-Gel layer, for example, with a volume content of pores of 10% to 60% of the total volume of the antireflective layer. These porous antireflective single layers can have a refractive index in the range of 1.2 to 1.38. The refractive index is—among other factors—dependent upon the porosity. The layer thickness of the single layer can be in the range of approximately 50 nm to 100 m.

For a multilayer structure of an antireflective coating, alternating layers consisting of medium-, high- and low refractive layers can be used, such as with three layers, whereby the uppermost layer can be a low refractive layer. Alternating layers consisting of high- and low refractive layers can also be provided, such as layers consisting of four or six layers, whereby the uppermost layer can be a low refractive layer.

In an additional embodiment, the antireflective coating consists of alternating high- and low refractive layers. The layer system has at least two, but also four, six and more layers. In the case of a two-layer system, for example, a first high refractive layer T can have a low refractive layer S applied thereon. High refractive layer T includes, for example, TiO₂, Nb₂O₅, Ta₂O₅, CeO₂, HfO₂, ZrO₂, CeO₂, as well as mixtures. Low refractive layer S can include a silicon oxide or silicon mixed oxide, such as oxides of Al, Zn, Mg, P, Ce, Zr, Ti, Cs, Ba, Sr, Nb, B and/or MgF₂. The refractive indexes (reference wavelength of 588 nm) for the high refractive layer T are, for example, at 1.7 to 2.6 and for the low refractive layer S, for example, at 1.35 to 1.7.

In another embodiment, the antireflective coating consists of alternating medium-, high- and low refractive layers. The layer system has at least three or five and more layers. In the case of a three-layer system, such coating includes an antireflective layer for the visible spectral range. These are interference filters from three layers with the following structure of individual layers: carrier material/M/T/S, wherein M is a layer having a medium refractive index (i.e. 1.6 to 1.8), T is a layer having a high refractive index (i.e. 1.9 to 2.3) and S is a layer having a low refractive index (i.e. 1.38 to 1.56). The medium refractive layer M includes, for example, a mixed oxide layer consisting of silicon oxide and titanium oxide, but an aluminum oxide can also be used. The high refractive layer T includes, for example, titanium oxide and the low refractive layer S includes, for example, silicon oxide or silicon mixed oxide, as previously described. The thickness of such individual layers is, for example, in the range of 50 to 150 nm.

In another embodiment, the antireflective layer includes a structure of several individual layers with different refractive index selected, for example, from titanium oxide, niobium oxide, tantalum oxide, cerium oxide, hafnium oxide, silicon oxide, magnesium fluoride, aluminum oxide, zircon oxide, yttrium oxide, gadolinium oxide, silicon nitrate or mixtures thereof, as well as other metal oxides that are known for use as antireflective coatings. Such a coating notably has, in an interference layer system, with at least four individual layers.

In another embodiment, an antireflective coating includes an interference layer system with at least five individual layers having the following layer structure: glass (carrier material)/M1/T1/M2/T2/S, wherein M1 and M2 each are a layer with medium refractive index (i.e. 1.6 to 1.8), T1 and T2 are layers with high refractive index (i.e. ≧1.9) and S is a layer with low refractive index (i.e. ≦1.58). The medium refractive layer M includes, for example, a mixed oxide layer consisting of silicon oxide and titanium oxide, but aluminum oxide or zinc oxide can also be used. The high refractive layer T includes, for example, titanium oxide, but also niobium oxide, tantalum oxide, cerium oxide, hafnium oxide and mixtures thereof can be used. The low refractive layer S includes, for example, a silicon oxide or silicon mixed oxide as previously described.

Antireflective or antireflection layers can also be additional layer systems that, through combination of different M-, T- and S-layers, can realize antireflection systems that deviate from the previously described systems.

With the antireflective coating comprising one or more layers, the total thickness can be in the range of approximately 50 nm to 100 μm.

Optical reflections can be clearly reduced not only through thin multiple coatings and mixtures of, for example, TiO₂ and SiO₂, but also through build-up of refractive value gradients, whereby refraction between substrate and air is avoided. This can occur, for example, through structuring of the surface (so-called moth-eye pattern). Therefore, a functional layer with appropriately structured surface can be used.

Photocatalytic layers as the functional layers can for example be selected from TiO₂ (anatase). SiO₂ can be added, as well as Al₂O₃.

Antimicrobial layers that can be used as functional layers are, for example, Ag, or other layers that contain additives that have an antimicrobial effect. These ions can, for example be introduced into the oxidic or nitride layers through doping, so that they are antimicrobially effective on the surface.

Decorative layers are, for example, colored SiO₂ layers, wherein mixed oxide layers can be used.

One possible electrochromic layer as the functional layer is, for example, a WO₃ layer that is applied onto a TCO-coated substrate.

Another exemplary coating in the embodiment of a functional layer is an adhesion promoting layer. The adhesion promoting layer can include one or several layers that possibly comprise one or several intermediate layers. An adhesion promoting layer containing silicon oxide or silicon mixed oxide can be provided, whereby in the latter case, in addition to silicon oxide, at least one oxide of aluminum, tin, magnesium, phosphorus, cerium, zircon, titanium, cesium, barium, strontium, niobium, zinc, boron and/or magnesium fluoride is present. In a silicon aluminum mixed oxide layer, the mol ratio of aluminum to silicon in the mixed oxide can be approximately in the range of 0.03 to approximately 0.30, such as approximately 0.05 to approximately 0.20 or approximately 0.07 to approximately 0.14.

One exemplary embodiment is an antireflective coating in the form of a thermally solidified Sol-Gel coating, whereby the uppermost layer is an adhesion promoting layer.

In another embodiment, the adhesion promoting layer as the uppermost layer or coating of an antireflective coating is a thermally solidified Sol-Gel mixed oxide layer. It can be a silicon oxide-mixed oxide layer, whereby an oxide of the following elements is present: aluminum, tin, magnesium, phosphorus, cerium, zircon, titanium, cesium, barium, strontium, niobium, zinc, boron and/or magnesium fluoride.

According to one exemplary embodiment, the coating applied onto the glass substrate, in particular the functional coating, has a porosity that may facilitate chemical prestressing. With a volume share of pores, this is at approximately 1 to 60%, such as 3 to 40%.

In one exemplary embodiment, a functional layer is a liquid phase coating, such as a thermally solidified Sol-Gel layer. The layer can be applied to the surface by dipping, vapor coating, spraying, printing, application with a roll, in a wipe application, coating or roll process and/or doctor blade or screen printing or by another suitable method. The functional layer can, however, also be a CVD (chemical vapor deposition) coating which, for example, is produced by PECVD, PICVD (plasma enhanced chemical vapor deposition), vacuum CVD or chemical vapor deposition at atmospheric pressure. The functional layer can also be a PVD (physical vapor deposition) coating (application by plasma enhanced physical vapor deposition) that is produced, for example, through sputtering, cathode sputtering under vacuum, enhanced by a magnetic field and/or ion beams, thermal evaporation, laser beam-, electron beam or arc evaporation. The functional layer can also be a flame pyrolysis layer.

Sol-Gel functional layers can be used, i.e. coatings consisting of one or more layers that provide the glass substrate with one or several functions and which are produced by use of a Sol-Gel process.

The Sol-Gel layers can also comprise a full-surface or partial-surface texture, as described, for example, in EP 1 909 971 B1.

An antiglare coating can therefore be produced, for example, by embossing a Sol-Gel layer or by addition of nanoparticles into the Sol-Gel solution, so that the roughness is increased and can be in the range of 5 nm to 5 μm.

An antiglare surface that is obtained for example, in the form of a matted and/or etched and/or textured surface can transform, the mirrored reflection into a dull reflection. This so-called scattering of the reflected light renders reflected images blurred, so that various shapes and reflected light sources do not distract from the object portrayed behind the glass. Scattering of the light does not reduce the overall reflection or the absorption of the radiated light on the glass or glass ceramic surface or in the glass or glass ceramic substrate. The light is not only directed, but is scattered in all directions in space. The total amount of light remains the same.

There are various options to produce a matted glass surface, for example, embossing of textures during the hot forming process or etching of the glass surface with acid.

Etched surfaces offer diffused scattering of bright reflected light and permit better recognition of transmitted images and texts. Textured surfaces are sometimes also used as alternative to antireflection coatings. The brilliance of directly reflected light sources is hereby reduced. Due to its structure, the surface displays reduced static friction coefficients in contact with a plurality of materials and surfaces. The herewith associated improved feel makes said surface especially attractive for use in touch-display applications. The reduced effective contact surface between such a textured surface and other touching surfaces leads to a purely mechanically induced “anti-fingerprint” functionality. Many times, this also motivates the use in touch-display applications. Contaminations, however, that have found their way into the structures of the surface are more difficult to remove than from a smooth surface.

Before application of the one or several functional layers, a treatment of the surface of the glass substrate may occur. It can, for example, be polished, roughened or textured, such as etched, depending on which surface properties are required, for example to fulfill the requirements of a good feel. The glass surface can thus be textured through etching to define surface qualities, roughness depth or gloss value.

The functional layers previously described can be the uppermost functional layer of any system, or all existing layers together can form a functional layer. The one or several functional layers can, as previously described, be applied to both sides of the glass substrate.

The functional layer can have a thickness greater than 1 nm, such as greater than 10 nm or greater than 20 nm. It is herein expedient if, under consideration of the depth of the interaction with the amphiphobic coating, the functional layer can be fully utilized.

Chemical Prestressing

After coating the glass substrate with one or more functional layers, the coated glass substrate is chemically prestressed.

The glass is subjected to an ion exchange to form a compressive stress layer that prevents mechanical damage, such as scratches or abrasion and is thus resistant to damages. Generally, in the ion exchange method, smaller alkali metal ions in the glass surface, for example sodium ions and/or lithium ions are exchanged with larger alkali metal ions, such as potassium ions, wherein the duration and temperature of the ion exchange process determine the layer depth of the exchange. If this ion exchange depth is greater than the damage in the surface of the product that occurs during use, breakage is prevented.

With exemplary glasses that can be coated according to the present invention, an increase in strength is achieved by a factor of at least 2—tested with the double ring test—compared to a glass with the same composition that is not prestressed, as is described in detail in FIG. 2.

Chemical prestressing is performed, for example, through immersion in a potassium-based melt. The possibility also exists to utilize an aqueous potassium silicate solution, paste or dispersion, as is described in WO 2011/120656. An additional possibility to chemically prestress glass is ion exchanged through vapor deposition or temperature-activated diffusion.

Chemical prestressing is characterized by the parameters of compressive stress and penetration depth. In the context of the present invention, “compressive stress” (CS) is understood to be the stress that results from the displacement effect upon the glass network through the glass surface after an ion exchange while no deformation occurs in the glass.

According to the present invention, “depth of the ion exchanged layer” or “ion exchange depth” (depth of ion exchanged layer, DoL) is understood to be the thickness of the glass surface layer where ion exchange occurs and compressive stress is produced. The DoL can, for example, be measured with the commercially available surface stress meter FSM6000, based on optical principles.

The ion exchange signifies that the glass is tempered or chemically prestressed through ion exchange—a method that is well known in the field of glass processing or refining. The salt that is typically used for chemical prestressing is K-containing molten salt or mixtures thereof. Conventionally used salts include KNO₃, KCl, K₂SO₄ or K₂Si₂O₅, additives such as NaOH, KOH and other soda salts or potassium salts, or cesium salts are also used to better control the rate of the ion exchange for chemical prestressing.

Potassium ions can, for example, replace sodium and/or lithium ions in the glass. Other alkali metal ions with larger atomic radius such as rubidium or cesium can alternatively replace smaller alkali metal ions in the glass. In one embodiment, the glass is chemically prestressed by dipping it into a molten salt bath containing KNO₂ for a predetermined time and at a certain temperature to achieve ion exchange.

The temperature of the molten salt bath is, for example, approximately 430° C. and the predetermined time period is approximately 8 hours.

Chemical prestressing by ion exchange can be performed on large glass components that are then cut or sawed into pieces, or are otherwise converted to attain a suitable size for the intended application in which they will be used. Chemical prestressing is alternatively performed on glass components that are already cut to size for the intended application.

The compressive surface stress attained by chemical prestressing relates to a stress that is created by replacing smaller alkali metal ions with alkali metal ions having a larger radius during the chemical prestressing process. Potassium ions are, for example, replaced with sodium and/or lithium ions.

The glass composition has great influence on the penetration depths and surface stress. For aluminosilicate and boroaluminosilicate glasses that were produced according to the present invention, exemplary surface stresses of CS≧600 MPa and penetration depths of DoL≧20 μm can be cited.

For potassium silicate glasses, such as B270i and D263 T that are marketed by SCHOTT AG, surface stresses of CS≧100, such as ≧200, or ≧300 MPs and penetration depths DOL≧5 can be obtained according to the present invention.

Glass Substrate

According to the present invention, the glass substrate is not further restricted, provided it contains sodium and/or lithium and is therefore suitable for ion exchange.

The glass thickness is also not limited within the scope of the present invention. The thickness can be less than or equal to 20 mm, less than or equal to 15 mm, less than or equal to 10 mm, less than or equal to 5 mm, less than or equal to 3 mm, less than or equal to 2 mm, less than or equal to 1.5 mm, less than or equal to 1.1 mm, less than or equal to 0.7 mm, less than or equal to 0.5 mm, less than or equal to 0.3 mm or less than or equal to 0.1 mm. At a glass thickness of less than or equal to 2 mm, the glass is classified as a thin glass within the context of the present invention.

The utilized glass compositions are also not limited. Exemplary glasses are lithium aluminum-silicate glasses, soda lime glasses, borosilicate glasses, aluminosilicate glasses and other glasses such as siliceous glasses, i.e., glasses whose network is formed predominantly by silicon dioxide, or lead glasses. Glass ceramic can be used instead of glass.

When the “glass substrate” is described within the scope of the present invention, it should be understood this can also refer to a glass ceramic substrate.

Exemplary glasses are lithium aluminum silicon glasses having the following composition or consisting thereof (in weight-%):

| | |
|---|---|
| SiO₂ | 55-69 |
| Al₂O₃ | 19-25 |
| Li₂O | 3-5 |
| Sum Na₂O + K₂O | 0-30 |
| Sum MgO + CaO + SrO + BaO | 0-5 |
| ZnO | 0-4 |
| TiO₂ | 0-5 |
| ZrO₂ | 0-3 |
| Sum TiO₂ + ZrO₂ + SnO₂ | 2-6 |
| P₂O₅ | 0-8 |
| F | 0-1 |
| B₂O₃ | 0-2. |

Other exemplary glasses are lime-silicon glasses having the following composition or consisting thereof (in weight-%)

| | |
|---|---|
| SiO₂ | 40-80 |
| Al₂O₃ | 0-6 |
| B₂O₃ | 0-5 |
| Sum Li₂O + Na₂O + K₂O | 5-30 |
| Sum MgO + CaO + SrO + BaO + ZnO | 5-30 |
| Sum TiO₂ + ZrO₂ | 0-7 |
| P₂O₅ | 0-2. |

Other exemplary glasses are borosilicate glasses having the following composition or consisting thereof (in weight-%)

| | |
|---|---|
| SiO₂ | 60-85 |
| Al₂O₃ | 1-10 |
| B₂O₃ | 5-20 |
| Sum Li₂O + Na₂O + K₂O | 2-16 |
| Sum MgO + CaO + SrO + BaO + ZnO | 0-15 |
| Sum TiO₂ + ZrO₂ | 0-5 |
| P₂O₅ | 0-2. |

Other exemplary glasses are alkali-aluminosilicate glasses having the following composition or consisting thereof (in weight-%)

| | |
|---|---|
| SiO₂ | 40-75 |
| Al₂O₃ | 10-30 |
| B₂O₃ | 0-20 |
| Sum Li₂O + Na₂O + K₂O | 4-30 |
| Sum MgO + CaO + SrO + BaO + ZnO | 0-15 |
| Sum TiO₂ + ZrO₂ | 0-15 |
| P₂O₅ | 0-10. |

Other exemplary glasses are low alkali-aluminosilicate glasses having the following composition or consisting thereof (in weight-%)

| | |
|---|---|
| SiO₂ | 50-75 |
| Al₂O₃ | 7-25 |
| B₂O₃ | 0-20 |
| Sum Li₂O + Na₂O + K₂O | 1-4 |
| Sum MgO + CaO + SrO + BaO + ZnO | 5-25 |
| Sum TiO₂ + ZrO₂ | 0-10 |
| P₂O₅ | 0-5. |

Other exemplary glasses are siliceous glasses having the following composition or consisting thereof (in weight-%)

| | |
|---|---|
| SiO₂ | 10-90 |
| Al₂O₃ | 0-40 |
| B₂O₃ | 0-80 |
| Na₂O | 1-30 |
| K₂O | 0-30 |
| CoO | 0-20 |
| NiO | 0-20 |
| Ni₂O₃ | 0-20 |
| MnO | 0-20 |
| CaO | 0-40 |
| BaO | 0-60 |
| ZnO | 0-40 |
| ZrO₂ | 0-10 |
| MnO₂ | 0-10 |
| CeO | 0-3 |
| SnO₂ | 0-2 |
| Sb₂O₃ | 0-2 |
| TiO₂ | 0-40 |
| P₂O₅ | 0-70 |
| MgO | 0-40 |
| SrO | 0-60 |
| Li₂O | 0-30 |
| Li₂O + Na₂O + K₂O | 1-30 |
| SiO₂ + B₂O₃ + P₂O₅ | 10-90 |
| Nd₂O₅ | 0-20 |
| V₂O₅ | 0-50 |
| Bi₂O₃ | 0-50 |
| SO₃ | 0-50 |
| SnO | 0-70 |

wherein the content has SiO₂+P₂O₅+B₂O₃ of 10-90 weight-%.

Other exemplary glasses are lead glasses having the following composition or consisting thereof (in weight-%)

| | |
|---|---|
| PbO | 20-80 |
| SiO₂ | 20-60 |
| K₂O | 0-10 |
| Na₂O | 1-10 |
| BaO | 0-20 |
| SrO | 0-20 |
| Al₂O₃ | 0-10 |
| CaO | 0-10 |
| F₂O₃ | 0-1 |
| Sb₂O₃ | 0-1 |
| ZnO | 0-20 |
| B₂O₃ | 0-20 |
| ZrO₂ | 0-10. |

The glass compositions may possibly contain additives of colored oxides, i.e. Nd₂O₃, Fe₂O₃, CoO, NiO, V₂O₅, MnO₂, TiO₂, CuO, CeO₂, Cr₂O₃, rare earth oxides in contents of 0-5 weight-% or, for “black glass”, 0-15 weight-%, and refining agents, such as As₂O₃, Sb₂O₃, SnO₂, SO₃, Cl, F, CeO₂, in contents of 0-2 weight-%. The components of the glass composition always result in 100 weight-%.

In one embodiment, the substrate is a glass ceramic consisting of ceramized aluminosilicate glass or lithium alumino silicate glass.

A glass ceramic or ceramized glass having the following composition of the starting glass can be used (in weight-%):

| | |
|---|---|
| Li₂O | 3.2-5.0 |
| Na₂O | 0-1.5 |
| K₂O | 0-1.5 |
| Sum Na₂O + K₂O | 0.2-2.0 |
| MgO | 0.1-2.2 |
| CaO | 0-1.5 |
| SrO | 0-1.5 |
| BaO | 0-2.5 |
| ZnO | 0-1.5 |
| Al₂O₃ | 19-25 |
| SiO₂ | 55-69 |
| TiO₂ | 1.0-5.0 |
| ZrO₂ | 1.0-2.5 |
| SnO₂ | 0-1.0 |
| Sum TiO₂ + ZrO₂ + SnO₂ | 2.5-5.0 |
| P₂O₅ | 0-3.0 |

In another embodiment, a glass ceramic or ceramizable glass having the following starting glass composition can be used (in weight-%):

| | |
|---|---|
| Li₂O | 3-5 |
| Na₂O | 0-1.5 |
| K₂O | 0-1.5 |
| Sum Na₂O + K₂O | 0.2-2 |
| MgO | 0.1-2.5 |
| CaO | 0-2 |
| SrO | 0-2 |
| BaO | 0-3 |
| ZnO | 0-1.5 |
| Al₂O₃ | 15-25 |
| SiO₂ | 50-75 |
| TiO₂ | 1-5 |
| ZrO₂ | 1-2.5 |
| SnO₂ | 0-1.0 |
| Sum TiO₂ + ZrO₂ + SnO₂ | 2.5-5 |
| P₂O₅ | 0-3.0. |

In another embodiment, a glass ceramic or ceramizable glass having the following starting glass composition can be used (in weight-%):

| | |
|---|---|
| Li₂O | 3-4.5 |
| Na₂O | 0-1.5 |
| K₂O | 0-1.5 |
| Sum Na₂O + K₂O | 02.-2 |
| MgO | 0-2 |
| CaO | 0-1.5 |
| SrO | 0-1.5 |
| BaO | 0-2.5 |
| ZnO | 0-2.5 |
| B₂O₃ | 0-1 |
| Al₂O₃ | 19-25 |
| SiO₂ | 55-69 |
| TiO₂ | 1.4-2.7 |
| ZrO₂ | 1.3-2.5 |
| SnO₂ | 0-0.4 |
| Sum TiO₂ + SnO₂ | less than 2.7 |
| P₂O₅ | 0-3 |
| Sum ZrO₂ + 0.87 (TiO₂ + SnO₂) | 3.6-4.3. |

The glass ceramic can contain high quartz mixed crystals or keatite mixed crystals as the predominant crystals phase. Crystal size can be less than 70 nm, such as less than or equal to 50 nm or less than or equal to 10 nm. The glass ceramic can be produced in a known manner.

Aluminum-containing glasses, for example Xensation® by Schott AG or Gorilla-Glass® by Corning Inc., can be effectively chemically stressed. In other words, it is possible with these products to achieve greater depths of layers and surface tensions, compared to soda-lime-silica glasses or crown glasses (for example B270i, distributed by Schott AG).

The largest share of the glass or starting glass for a glass ceramic is generally SiO₂ which is a matrix creator of the glass and is present in the exemplary glasses in the stated range. SiO₂ increases the viscosity which supports formability and provides the glass with chemical stability. If the content is higher than the stated range, the SiO₂ increases the melting temperature in an undesirable manner, whereas the glass stability generally decreases at concentrations below the range. In addition, lower SiO₂ concentrations in glasses with high K₂O or high MgO concentrations cause the liquidus temperature to rise. The liquidus temperature describes the temperature of a glass below which the mixture of a homogenous liquid phase starts to solidify.

If Al₂O₃ is present in the respective range, it increases the viscosity. With Al₂O₃ concentrations which are higher, the viscosity can become too great and the liquidus temperature may also become too high, especially for performing a continuous downdraw process.

To obtain melting temperatures that are suitable for a continuous production process, fluxing agents can be used. The oxides Na₂O, K₂O, B₂O₃, MgO, CaO and SrO, for example, act as fluxing agents. To fulfill the various boundary conditions during melting, the temperature of the glass at a viscosity of 200 poise may be no higher than 1650° C.

Alkali metal oxides serve as aids in achieving low liquidus temperatures and low melting temperatures. The melting temperature relates to the temperature at a glass viscosity of 200 poise. To make an ion exchange possible and to obtain greater glass strength, Na₂O can be used in the respectively cited range. If the glass consists exclusively of Na₂O, Al₂O₃ and SiO₂, the viscosity would be too great for suitable melting. It is therefore useful that other combinations are available to ensure good melting and good shaping. Under the assumption that these components are present, suitable melting temperatures, are for example, achieved if the Na₂O concentration clearly differs from the Al₂O₃ concentration, for example, by at least approximately 2 to approximately 6 weight-%. Other alternatives are also possible.

Potassium oxide (K₂O) is present to achieve low liquidus temperatures. However, K₂O, more than Na₂O, can lower the viscosity of the glass. It is therefore useful to select the concentrations appropriately.

In one embodiment, the glass is substantially free of lithium, meaning that lithium is not added to the glass or the glass raw material during any process step so that possibly insignificant amounts of lithium are contained by the glass due to impurities or unavoidable contaminations. The absence of lithium reduces the contamination of ion exchange baths, so that the salt bath for chemical prestressing does not need to be replaced or replenished up every time. The glass without lithium is also further convertible with continuous melting technology, such as a downdraw method.

The alkali ions are not very mobile because of their size, so that on one hand a chemical hardening of the glass is enabled but on the other hand the chemical resistance of the flat glass can be impaired. As such, care should be taken when selecting the alkali metal oxide contents.

B₂O₂ serves as a fluxing agent, i.e. a component that is added to reduce the melting temperature. Even the addition of small amounts, for example 2 weight-% of B₂O₂ or less, can reduce the melting temperature of otherwise equivalent glasses by 100° C. Whereas, as previously described, sodium is added to enable an appropriate ion exchange, it may be desirable to add a relatively low amount of Na₂O and a high amount of Al₂O₃ to ensure the formation of a meltable glass.

If the total alkali metal oxide concentration exceeds the one of Al₂O₃, then each earth alkali oxide that is present in the glass serves as a fluxing agent; MgO is the most effective fluxing agent but, in small MgO concentrations, tends to form forsterite (Mg₂SiO₄) and results in the liquidus temperature of the glass with the MgO to increase sharply. With higher MgO amounts, the glasses have melting temperatures that are well within the necessary limits for continuous production. However, the liquidus temperature may be too high and thus the liquidus viscosity too low to be compatible with a downdraw process, for example the fusion draw process. However, the addition of at least one of B₂O₃ or CaO can reduce the liquidus temperature of this MgO-rich composition drastically. In fact, a certain amount of B₂O₃, CaO or both may be necessary to obtain a liquidus viscosity that is suitable for the fusion draw process, especially with glasses having high sodium-, low K₂O and high Al₂O₃ concentrations. It is expected that SrO has precisely the same influence upon the liquidus temperature of glasses having a high MgO content as CaO.

Barium is also an earth alkali metal and additions of small amounts of barium oxide (BaO) or replacement of BaO through other earth alkali metals can produce lower liquidus temperatures by the earth alkali-rich crystalline phases being destabilized. However, barium is a hazardous substance and toxic material. Thus, barium oxide can be added to the herein described glasses in an amount of at least 2 weight-% without negative effects, or even with a small improvement in the liquidus viscosity, but the BaO content is generally kept low to minimize the effect of the glass on the environment. In one embodiment, the glass can thus be essentially free of barium.

In addition to the elements described above, other elements and compounds can be added to eliminate or reduce defects in the glass.

The method of producing glasses is not limited in the scope of the present invention. The herein described glasses can, for example, be produced in methods such as floating, draw up, down draw, slot draw method or overflow fusion or through rolls. In all these methods, it is appropriate that the glass has a high resistance against crystallization and does not contain too high a share of reduction-sensitive components. Glasses that are processed with the described method must be kept over a long time at high temperature, which can easily cause crystallization. The herein described lead containing glasses are cast, or cast and rolled, into blocks or other shapes and are rapidly cooled so that no crystallization occurs.

The glass substrate can moreover have a textured or patterned surface that was produced prior to application of the at least one functional layer. Texturing can be obtained through acidic and/or alkaline etching in order to provide a roughness, in the range of 5 nm to 5 μm (5000 nm), such as 50 nm to 5 μm. The roughness can be measured with known technology. Texturing can alternatively be obtained lithographically or through structures applied with other methods.

The surface properties, roughness depth or gloss values of the surface of a glass can for, example, be specifically set for various fields of application through the use of an etching-dipping process.

Activation of Functional Coating on the Glass Surface

After chemical prestressing, but before application of the amphiphobic coating, the at least one functional layer present on the glass substrate is activated.

In the chemical prestressing process, sodium and/or lithium ions from the glass substrate are exchanged with potassium ions. This exchange provides the glass with compressive strength, as previously described. The ion exchange occurs not only in the glass substrate, but also in the functional layer placed upon it. It is assumed that after chemical prestressing, an accumulation of exchanged alkali metal ions, generally potassium ions, occurs in the surface-near regions of the glass substrate as well as in the functional layer.

The long-term stability of an amphiphobic coating is regularly being degraded through chemical prestressing. According to the present invention, this disadvantage can be removed. According to the present invention, the at least one functional layer is activated after chemical prestressing, so that the surface of the functional layer interacts with an amphiphobic coating that is to be applied.

It is theorized that, through enrichment of alkali ions in the surface of the uppermost functional layer, the number of active bonding sites, for example Si—OH in a Si-containing functional layer, are reduced, thus inhibiting covalent bonding to the amphiphobic coating so that the amphiphobic coating has poorer adhesion and lower long-term stability. The surface of the uppermost functional layer is, in addition, generally burdened with inorganic and organic contamination, which can counter the desired interaction.

In contrast to known methods, an activation of the surface of the outermost or uppermost functional layer is therefore performed according to the present invention before the amphiphobic coating is applied. Through this, free bonding sites are created on the surface of the uppermost layer. The created free bonding sites, for example active Si—OH ensure that the amphiphobic coating applied thereupon has better adhesion, making it possible to clearly increase the long-term durability of an amphiphobic coating that is to be applied thereupon.

According to the present invention, the activation of the surface can also result in that it becomes “rougher”. Due to the increased roughness, the anchoring of the amphiphobic coating can be improved.

The activation of the surface of the functional layer (if only one functional layer is present), in particular of the surface of the outermost or uppermost functional layer (if several functional layers are present), can be performed by use of one of the following alternatives:
(1) Treating the surface with alkali-containing aqueous solution, which can have a pH>9 and subsequent washing with water, such as deionized or demineralized water.
(2) Treating the surface with an acidic aqueous solution, which can have a pH<6 and subsequent washing with water, such as deionized or demineralized water;
(3) Treating the surface with alkaline aqueous solution, which can have a pH>9, followed by treating the surface with an acidic aqueous solution, which can have a pH<6 and subsequent washing with water, such as deionized or demineralized water;
(4) Washing the surface with an aqueous washing solution containing one or several tensides, then rinsing with water, such as deionized or demineralized water;
(5) Washing the surface with water, such as deionized or demineralized water;
(6) Alternative 1), alternative 2), alternative 3) or alternative 4), respectively, combined with ultrasonic cleaning;
(7) Treating the surface with oxygen-plasma; and
(8) alternative 1), alternative 2), alternative 3) alternative 4), alternative 5) or alternative 6), respectively, combined with oxygen-plasma treatment;

The selected alternative depends on the glass composition and the composition and structure of the coating. One skilled in the art is capable of selecting a suitable alternative, and to optimize the same through routine experimentation.

The exemplary method is therefore based on a chemical treatment, possibly combined with a mechanical treatment and physical cleaning. The chemical treatment can be performed with an acidic and/or alkaline aqueous solution, a tenside-containing wash solution and/or with water. Several chemical treatments can be performed simultaneously (i.e. alternative (3)) and are possibly combined with a mechanical treatment such as an ultrasonic cleaning (alternative (6)).

The type of surface treatment of the at least one functional layer is not limited within the scope of the present invention. For example, the treatment solution can be applied to surface of the functional layer through spreading, infusion, spraying, dipping or another method. The treatment is performed for a defined time period, such as over several minutes at a temperature in the range of ambient temperature (20° C.) to below the boiling point of the solvent, such as in the range of 20 to 95° C., in the range of 20 to 80° C., or in the range of 20 to 60° C.

The alkaline solutions that are used are not particularly limited. Any alkali-containing aqueous solution having a pH-value above 9 can be used. The alkali-containing aqueous solution can contain sodium and/or potassium ions. The alkali-containing aqueous solution is selected, for example, from an aqueous NaOH-, KOH-, sodium silicate-, potassium silicate-, soda phosphate-, potassium phosphate-solution which optionally contains NH₄OH, or mixtures thereof.

Moreover, any acidic aqueous fluid can be used. For example, inorganic or organic acids can be used in an aqueous solution. Examples, without limitation thereto, are sulfuric acid, hydrochloric acid, perchloric acid, nitric acid, phosphoric acid, acetic acid, trifluoroacetic acid, perfluoroacetic acid, oxalic acid or citric acid, as well as mixtures thereof.

Depending on the combination of the base or acid, which is, for example, in the range of 0.01 to 1 molar, the treatment is performed for several minutes at a temperature in the range of room temperature to a temperature of below boiling point of water. The activation is performed, for example, by using a 0.3 to 0.5 molar sulfuric acid solution for a duration of 5 to 15 minutes at room temperature (20° C.).

Any known compositions containing one or more tensides that do not negatively affect the coated glass substrate can be considered as an aqueous solution. Nonionic, cationic, anionic or amphoteric tensides, or mixtures thereof, which have become known can be used. The wash solution can also contain a known neutral cleaner.

If necessary, the chemical treatment can be supported with ultrasound (alternative (6)).

Subsequently, rinsing with water occurs, such as with deionized or demineralized water.

Activation occurs, therefore, substantially in the form of an alkaline, acidic, and/or aqueous treatment of the surface of the outermost or uppermost layer that was applied onto the chemically prestressed glass substrate. Activation prior to the application of an amphiphobic coating therefore increases the adhesion of the coating that is to be applied and moreover improves the long-term stability of the amphiphobic coating.

After the activation treatment, optional drying can be performed, in particular with alternatives (1), (2), (3), (4) and (6). This can occur through air drying, in an oxygen atmosphere, by use of heated air, by use of a radiator or through an increased supply of air.

The activation treatment is performed directly prior to application of the amphiphobic coating, and can be performed without an intermediate step.

The activation can be conducted such that the ions that previously entered the functional layer due to the ion exchange are again removed from the surface of the functional layer. The activation can be performed such that the strength, impact and breaking resistance, the optical and mechanical properties and the chemical stability of the functional layer or layers are not negatively affected.

With the chemical treatment of the surface of the functional layer, chemical dissolution of impurities occurs. The chemical treatment additionally causes an ion exchange, in particular between H₃O⁺ and alkali ions. Porous, low-alkali gel layers and hydrated layers form, whereby the number of active groups, such as for example Si—OH-groups in an Si-containing functional layer, facilitate good adhesion of an amphiphobic coating on the functional layer.

The depth to which the exchanged alkali metal ions, especially the potassium ions or sodium ions, are removed is variable and can even reach to or into the glass substrate. A depth of up to 10 nm from the surface of the functional layer, particularly of the uppermost or outermost functional layer, or up to 50 nm, or up to 100 nm can be reached, so that the removal can reach as far as the interface of glass substrate/functional layer(s) or even as far as into the glass substrate.

The selection of the appropriate chemicals, their concentration, used volumes and process parameters for the activation depends to a large extent on the composition of the layer, as previously described. Whereas, for example, layers with high SiO₂ content, for example >75 mol % are generally very resistant against various reagents, layers with low SiO₂ content can display changes in properties, e.g. optical, mechanical, etc., after a chemical treatment that is too aggressive.

In addition, a reactive dissolution of the surface of the functional layer may occur during activation, especially in the case of solutions with pH>9. Due to the dissolution, active groups like Si—OH groups, in the case of Si-containing functional layers, are also produced. Such a change in the properties due to the activation treatment, in particular dissolution, of the surface of the functional layer is undesirable.

When activating the surface of the functional layer, it is therefore important that the reagents are selected such that the mechanical stress of the chemically prestressed glass, in particular the strength, impact and breaking resistance, the optical and mechanical properties and the chemical stability of the functional layer, and the functional layer together with the glass substrate are not negatively affected. This can be easily accomplished by one skilled in the art.

The previously described treatment alternatives result in such activation of the surface of the functional layer that was subjected to the ion exchange, that the subsequently applied amphiphobic coating adheres better and in a homogeneous manner on the glass. Activation of the glass surface, and the functional layer(s) disposed thereupon, expresses itself in the hydrophilic properties. These hydrophilic properties can be determined by observing whether atomized water distributes itself homogeneously on the surface. An additional possibility is, for example, through measuring the surface tension, for example by using calibration fluid such as Plasmatreat®. The activation treatment according to the present invention results in an activated and hydrophilic surface which, as a rule, has a slightly reduced surface tension at, for example, 44 mN/m or more at each point.

After chemical prestressing, the subsequent activation of the surface of the functional coating can, for example, be performed such that the alkali ions are removed from the entire functional layer, but only to a depth of the interface between functional layer and glass substrate, such as to 100 nm of the surface of the outermost layer, to 50 nm, or to 10 nm. However, only the surface-near alkali ions such as potassium ions, lithium ions, sodium ions or such like maybe removed, so that the benefits of chemical prestressing and the properties of the coated glass substrate remain intact.

According to the present invention, one or both sides of the glass substrate can be provided with one or more functional layers. Then, both or only one side of the coated and chemically prestressed glass substrate can be activated and an amphiphobic coating, consisting of one or several layers be applied. According to the present invention, only one side of the ion exchanged glass substrate that is coated with the functional layer may be activated while the other side is covered with a protective layer in such a way that the alkali ions, in particular the potassium ions, are removed only on one side. The amphiphobic coating is then subsequently applied only on the activated side.

Amphiphobic Coating

After activation of the coated glass substrate, an amphiphobic coating is applied which may also be known as an “anti-fingerprint” coating. Such an amphiphobic coating is not especially limited, and any known coating can be applied with the relevant anti-fingerprint coating.

An amphiphobic coating is a coating that serves to suppress, avoid and/or reduce the development of fingerprints through touching by the user. Fingerprints contain predominantly salts, amino acids and fats, substances such as talcum, sweat, residues of dead skin cells, cosmetics and lotions and possibly dirt in the form of liquid and particles of various types. An amphiphobic coating must, therefore, be resistant to water, salt and fat deposits that occur, for example in residues of fingerprints during use by the operator. The coating can have dirt repelling properties and be easy to clean.

Amphiphobic layers include easy-to-clean coatings, anti-fingerprint coatings and anti-adhesion coatings. In an anti-adhesion coating, the layers appear very smooth, so that a mechanical surface protection is achieved. Normally, these layers have several properties from the easy-to-clean, anti-adhesion, anti-fingerprint or smoothing surface category. Each of the following points is herein better suited in one area, so that with selection of the correct type, optimum properties can be achieved.

The amphiphobic coating can be, for example, a surface layer on a fluorine basis, containing a fluororganic compound, or a layer comprising a silane, the alkyl and/or fluor-alkyl groups, for example 3,3,3-trifluoropropyl-trimethoxysilane or pentyltriethoxysilane, that provides hydrophobic or oleophobic, that is amphiphobic, properties in such a manner that wetting of the surface by water and oil is minimized. The wetting characteristic of a surface having an amphiphobic coating must therefore be such that the surface is hydrophobic, where the contact angle between surface and water is greater than 90° and also is oleophobic, where the contact angle between surface and oil is greater than 50°.

The amphiphobic coating can, for example, be a surface layer on fluorine basis that is based on combinations with hydrocarbon groups, whereby the C—H compounds are replaced partially or primarily by C—F compounds. Such compounds can be perfluoro-hydrocarbons with the formula, for example, of (R_{F})ₙSiX₄₋ₙ, wherein R_{F} represents a C₁ to C₂₂ alkyl-perfluorohydrocarbon or alkyl-perfluoropolyether, such as C₁ to C₁₀ alkyl-perfluorohydrocarbon or alkyl-perfluoropolyether; n is an integer of 1 to 3, X is a hydrolysable group such as halogen or an alkoxyl group —OR in which R, for example, represents a linear or branched hydrocarbon with 1 to 6 carbon atoms. In this case, the hydrolysable group X can react, for example, with terminal OH group of the glass substrate's coating and thus bind to the same through creation of a covalent bond. Due to the low polarity of the terminal fluoro surface bonds, perfluorohydrocarbons can be used to reduce the surface energy of the surface

The amphiphobic coating can, for example, derive also from a mono layer of a molecular chain with fluorine terminal groups, a fluoropolymer coating or from silicon oxide soot particles that were previously provided with fluorine terminal groups or were treated with same.

Amphiphobic coatings are described, for example, in DE 19848591, EP 0 844 265, US 2010/0279068, US 2010/0285272, US 2009/0197048 and WO 2012/163947 A1, the disclosures of which are incorporated herein by reference. Known amphiphobic coatings are, for example, produces based on perfluoropolyether known as “Fluorolink® PFPE”, such as “Fluorolink® S10”, by Solvay Solexis or “Optool™ DSX” or “Optool™ AES4-E” by Daikin Industries LTD, “Hymocer® EKG 6000N” by ETC Products GmbH or fluorosilane known as “FSD”, such as “FSD 2500” or “FSD 4500” by Cytonix LLC or Easy-Clean-Coating “ECC”-products, such as “ECC 3000” or “ECC 4000”, by 3M Deutschland GmbH. These are layer applied as liquid. Anti-fingerprint coatings, for example in the form of nanolayer systems that are applied by physical vapor deposition, are offered by Cotec GmbH under the trade name of “DURALON Ultra Tec”.

The coating can be applied to the surface by dipping, vapor coating, spraying, application with a roller or doctor blade or other suitable methods. After the coating is applied, it is hardened at a suitable temperature for a suitable period of time.

Surprisingly, it has been found that the long-term durability of the amphiphobic coating in the embodiment of an anti-fingerprint coating can be clearly increased by activating the surface of the outermost functional layer. It is of special significance that the activation step is performed after coating and chemical prestressing of the glass substrate, so that the activation effect in terms of a removal of exchanged ions affects the applied coating in regard to its properties such, that clearly an increased adhesion ability for the anti-fingerprint coating placed thereupon is achieved.

The functional layer on the glass substrate can be selected such that it contains, or consists of, SiO₂. A functional coating of this type is, for example, an antireflective coating consisting of one or several layers, whereby the single or uppermost layer of a layer structure contains, or consists of, SiO₂. The functional coating can, for example, also be an adhesion promoting layer or cover layer or suchlike, containing or consisting of SiO₂. Such layers include an increased number of Si-containing terminal groups that are available for bonding to the amphiphobic coating, and therefore contribute to improved adhesion of the coating. The activation causes an interaction between the outermost or uppermost functional layer and the amphiphobic coating. Further, a covalent bond may even be created hereby with consequently better adhesion, thus improving the long-term stability.

Tests with a coated glass substrate upon which an applied amphiphobic coating was showed that the activation of the coating with an amphiphobic material additionally improves the swiping performance, which is ascribed to the increased adhesion of the amphiphobic coating on the surface of the glass substrate. It was also observed that activation of the functional layer prior to application of the amphiphobic coating clearly increases the adhesion of the amphiphobic coating on the coated glass substrate and improves the wettability and the long-term stability of the surface.

Combination of Antireflective and Amphiphobic Coating

According to one exemplary embodiment, the functional layer that is applied to the glass substrate, such as in the form of an inorganic functional layer, is selected as an antireflective coating in a single or multilayer configuration, whereby the outermost or uppermost layer interacts with the amphiphobic coating due to the activation.

The antireflective coating serves to eliminate the optical interference due to reflection and to thus eliminate the gloss and permits uninterrupted recognition by the user.

By applying the amphiphobic coating, the resulting surface is covalent, and possible bonding to foreign particles and oils—for example resulting from fingerprints—are reduced to a minimum. The resulting treated surface has a very low surface energy and a low abrasion coefficient.

A combination of antireflective and amphiphobic coating has the added benefit that the antireflective coating provides gloss elimination, so that a fingerprint present on the surface and that acts as an only source for an optical interference can simply be wiped off.

Through activation according to the present invention of at least the outermost or uppermost layer of the antireflective (AR) coating, an improved long-term durability of the amphiphobic coating can be achieved. For the amphiphobic coating, there are a multitude of tie-in possibilities on the coating on the glass substrate so that the amphiphobic coating adheres to the surface. Through activation of the coated glass substrate, the ions that are present as a result of the ion exchange are partially removed, whereby the number of active surface locations for tie-in are significantly increased.

Removal of fingerprints is normally performed by wiping the surface with a wet or dry cloth. Fingerprints can hereby be effortlessly removed from the amphiphobic surface, whereas dirt and the number and frequency of cleaning processes that in turn can lead to immediate or later defects and damage to the surface are reduced.

A cleaning cloth is frequently reused and contains dirt and particles that can scratch the surface. However, the scratch resistance of the coated glass substrate formed according to the present invention is also improved. The increased chemical hardness of the chemically prestressed coated glass, as well as its large compressive stress layer (DoL), prevent damage caused by repeated wiping.

The amphiphobic coating moreover provides the antireflective coated chemically prestressed glass substrate with abrasion resistance. Due to the compressive stress layer, the coated glass substrate has improved scratch- and breaking resistance, as well as damage resistance. The coated glass substrate also has anti-fingerprint and dirt-repelling characteristics that limit the transfer of oils from fingers to the surface through fingerprints, and allow for easy removal of the oils/fingerprints through wiping with a cloth.

A coated, chemically prestressed amphiphobic glass substrate that, based on the activation of the coated glass substrate, possesses an especially good long-term stability of the amphiphobic coating provided thereupon and finds versatile use, for example, for mobile telephones, navigation devices, tablets, laptops, furniture and household appliances and such. The described combination of properties is beneficial in particular, also for hand held devices with displays, whereby the coated glass substrate has high compressive stress, and is amphiphobic and antireflective coating.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustration of a coated glass substrate formed according to an exemplary embodiment of the present invention;

FIG. 2 is a diagram illustrating the breaking strength by a double ring test according to DIN EN 1288-5 (by excluding marginal influences) for a soda lime silicate glass K1 that is not chemically prestressed, a chemically prestressed soda lime silicate glass K2 with an antireflective coating, have a chemically prestressed soda lime silicate glass K3 with an antireflective coating, and an amphiphobic coating formed according to an exemplary embodiment of the present invention; and

FIG. 3 is a diagram wherein a reflection of a soda lime silicate glass that was not produced according to the invention is compared with an embodiment of a soda lime silicate glass produced according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

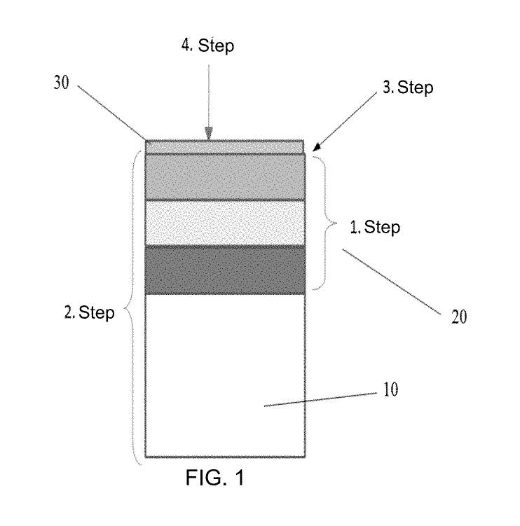

FIG. 1 is a schematic illustration of a coated glass substrate formed according to an exemplary embodiment of the present invention.

A glass substrate 10, which can also be textured, is coated according to an exemplary method in a first step with at least one functional layer 20. Within the scope of the invention, this can be any desired functional coating, representing one layer or several layers. In the illustrated example, this is an antireflective coating comprising three layers with a medium refractive, high refractive and low refractive layer-system. A different functional coating can be present in one or more layers.

Glass substrate 10 can also be coated on both sides (not illustrated).

In a second step, glass substrate 10, together with functional coating 20, is chemically prestressed. This can occur in a conventional manner. For example, glass substrate 10 that is coated with the antireflective layer system 20 and that has a thickness, for example, of 1.1 mm is subjected to an ion exchange through dipping into an ion exchange bath, using potassium ions as the replacement ions for Na- and/or Li-ions, whereby immersion occurs for a sufficient duration at an appropriate temperature such that the potassium ions replace the existing Na- and/or Li-ions. Depending on the glass composition and the type of coating, the relevant parameters are established. For aluminosilicate and boroaluminosilicate glasses a penetration depth of, for example, DoL≧20 μm can be obtained and for soda-lime silicate glasses a penetration depth of DoL≧5 μm can be obtained. The ion exchange occurs on the coated side of glass substrate 10 through the antireflective layer system 20.

Subsequently, the activation process, with which the uppermost layer or outermost surface of functional coating 20 is treated, is performed. For this purpose, an NaOH-containing aqueous solution is sprayed onto the uppermost or outermost layer of the illustrated exemplary antireflective coating 20 and is subsequently washed with deionized water. The treatment duration and temperature are not particularly limited if the treated layer is not touched. Exemplary treatment times range from a few minutes, for example 0.1 minutes to 30 minutes. Exemplary treatment temperatures range from ambient temperature to boiling temperature of water, for example 20° C. to 95° C. The treatment temperature is selected from the stated range and is then maintained for the duration of the treatment. Other activation alternatives, as previously described, are also possible.

An amphiphobic coating 30 is subsequently applied onto antireflective coating 20 in a fourth step. This can, for example, be one or several layers on fluorine basis, or one or more silane-containing layers. Other known amphiphobic layers are also possible. The amphiphobic layer typically has a thickness in the range of 1 to 10 nm, such as 1 to 4 nm or 1 to 2 nm. As a result of amphiphobic coating 30, the glass article displays reduced adhesion of fingerprints and effortless removability of same. The amphiphobic surface is covalent and contributes to the fact that fingerprints and contaminations or dirt cannot easily adhere, so that a transfer of oils and contaminants from fingers onto the glass surface is minimized. The amphiphobic surface of the product further improves the removability of fingerprints while contaminations are minimized and the number of cleaning procedures are reduced. A reduction in the number and frequency of the cleaning procedures also reduces the possibility of damage to the glass surface caused by cleaning.

Due to activation, the surface of antireflective coating 20 interacts with amphiphobic coating 30, so that the amphiphobic coating possesses greater long-term stability and so that the beneficial properties of the amphiphobic coating—such as the anti-fingerprint characteristic—are maintained over a considerably longer tie than without the activation process.

Due to the combination of chemical prestressing and subsequent activation of the coated glass substrate, the amphiphobic coating applied onto the coated glass substrate herewith displays a considerably greater long-term stability than would be achieved without activation of glass substrate and coating. As previously described, the properties of the amphiphobic coating are also positively influenced.

It was noted that, even if the content of alkali ions in the glass substrate and the uppermost layer is high, the amphiphobic coating is nevertheless long-term stable. The number of active bonding sites, for example of active Si—OH-groups, is probably high enough due to one of the described activation variations in order to interact with the amphiphobic coating. Therefore, when activating the surface of the uppermost or outermost functional layer, already a very limited removal of alkali ions is sufficient to activate the surface of the functional layer in a sufficient manner.

FIG. 2 is a diagram wherein the breaking strength values are expressed in MPa for a soda lime silicate glass K1 that is not chemically prestressed; a chemically prestressed soda lime silicate glass K2 with an antireflective coating; and a chemically prestressed soda lime silicate glass K3 with an antireflective coating; and an amphiphobic coating formed according to an exemplary embodiment of the present invention. The stated breaking strength values were determined through a double ring test according to DIN EN 1288-5 (by excluding marginal influences) and through calculation according to DIN EN 12337-2. The calculation is based on a Weibull distribution. The test sizes were 100×100×4 mm². Glasses K1, K2 and K3 have the same composition.

The prestressed, coated glasses formed according to the present invention have an increase in strength compared to glasses having the same composition but that were not prestressed; an increase in strength by a factor of at least 2 was achieved. The beneficial properties of the exemplary glass substrate K3 that are achieved with chemical prestressing are therefore not negatively impacted by the forming method.

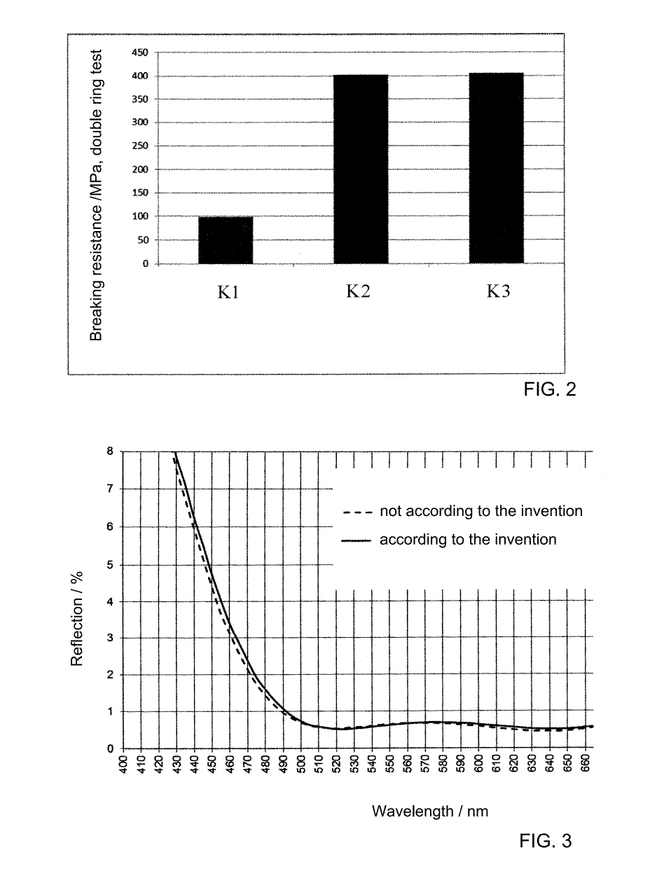

FIG. 3 is a diagram wherein the reflective behavior of a soda lime silicate glass that was not produced according to the present invention is compared with a soda lime silicate glass produced according to the present invention. The reflection is protracted in % against the wavelength in nm.

Two soda lime silicate glasses with the same composition were used—one was produced with a method according to the present invention while the other one was not. The broken line shows the reflection of a chemically prestressed soda lime silicate glass with an antireflective (AR) coating, which is not according to the reflection. The solid line shows the reflection of a chemically prestressed soda lime silicate glass that, after chemical prestressing underwent a surface activation and was subsequently provided with an amphiphobic coating (according to the present invention).

FIG. 3 therefore shows, that the optical properties of the glass substrate that is produced according to the present invention are changed only very slightly.

Neutral Salt Spray Test (NSS-Test) for Evaluation of the Properties of the “Amphiphobic” Coating

In order to substantiate that the substrates produced according to the present invention have better properties, especially long-term properties, if the surface is activated prior to coating with the amphiphobic coating, the substrates underwent testing. To obtain a measure for the long-term durability, a contact angle measurement was performed after a long-lasting NSS-test (neutral salt spray test according to DIN EN 1096-2:2001-05).

For the herein illustrated test results, deionized water was used as the measuring fluid. The error tolerance of the measurement results is ±3°.

The neutral salt spray test in which the coated glass samples were exposed to a neutral salt water atmosphere for 21 days at constant temperature proved to be an especially challenging test. The saltwater spray mist causes stress in the coating. The glass samples are placed in a specimen holder, so that the samples form an angle with the vertical of 15±5°. The neutral salt solution was produced by dissolving pure NaCl in deionized water, so that a concentration of 50±5 g/l at 25±2° C. was achieved. The salt solution was atomized via an appropriate nozzle in order to produce the salt spray mist. The operating temperature of the test chamber was 35±2° C.

Before the test and after 504 hours of test time, the contact angle to water was measured to characterize the stability of the hydrophobic property.

The amphiphobic coating used in the current example was Optool™ AES4-E by Daikin Industries Ltd., a perfluoroether with terminal silane residue.

An AR-coating produced in a Sol-Gel process was used as the functional layer. The glasses were dipped and cured at 500° C.

For this purpose, the glass piece was first provided with a three-layer Sol-Gel coating in the embodiment of a medium refractive, high refractive and low refractive layer-system with the aforementioned properties. Then it was prestressed in a potassium-containing salt melt. The surface was subsequently activated and immediately thereafter provided with an amphiphobic coating.

The layers wee specifically produced as follows:

Production of Stock Solution SiO₂:

103 ml tetra-ethoxy-silane were added to 218 ml ethanol. The solution was then mixed with 65 ml H₂O and hydrolyzed with acetic acid. The solution was subsequently mixed with 608 ml ethanol and stopped with hydrochloric acid. This stock solution could be used directly as coating solution.

Production of Stock Solution TiO₂ (Amorphous):

109 g of an amorphous TiO₂ precursor powder was added to 802 g ethanol and 89 g 15 pentanediol.

For the synthesis of the TiO₂ precursor powder, 1 mol titanium-tetra-ethylate was mixed with 1 mol acetylacetone and was subsequently hydrolyzed with 5 mol H₂O. P-toluene sulfonic acid could optionally be added to the hydrolysis water. After removal of the solvent, the powder was dried for five hours at 125° C. The amorphous precursor powder had a titanium oxide content of approximately 58 weight-%.

1. Solution—medium refractive layer
Coating solution C comprised a mixture of stock solution SiO₂ and stock solution TiO₂ (amorphous) at a ratio of weight-% of the oxides of 75:25.
2. Solution—high refractive layer

### Stock Solution TiO₂.

3. Solution—low refractive layer
While stirring, 60.5 ml silicic acid tetra-ethyl-ester, 30 ml distilled water and 11.4 g 1M nitric acid were added to 125 ml ethanol. After the addition of water and nitric acid, the solution was stirred for 10 minutes, whereby the temperature did not exceed 40° C. If required, the solution had to be cooled. The solution was then diluted with 675 ml ethanol. After 24 hours, 10.9 g Al(NO₃)₃×9 H₂O, dissolved in 95 ml ethanol and 5 ml acetylacetone were added to this solution.

For the first Sol-Gel layer that was applied directly onto the suitable glass substrate, coating solution 1 was applied. The applied Sol-Gel layer was dried for 15 minutes at 125° C. and cured. Subsequently, a Sol-Gel layer from coating solution 2 was applied and dried. Then, a Sol-Gel layer from coating solution 3 was applied and again dried.

After drying of the last applied layer, the thereby obtained layer package was cured for 15 minutes at 470° C.

The results are summarized in the following table 1:

TABLE 1

| | | | Contact angle | |
|---|---|---|---|---|
| | | | measurement in [°] | |
| | | Surface | | after 504 h |
| | | stress | Before NSS- | neutral salt-spray |
| Glass | Activation | [mN/m] | Test | test (NSS) |
| 1. Soda lime-silicate | — | 38 | 115 | 70 |
| glass | | | | |
| prestressed | | | | |
| 2. Aluminosilicate glass | — | 40 | 117 | 68 |
| prestressed | | | | |
| 3. Soda lime-silicate | — | 42 | 115 | 95 |
| glass | | | | |
| with functional layers | | | | |
| prestressed | | | | |
| 4. Aluminosilicate | — | 40 | 114 | 96 |
| glass | | | | |
| with functional layers | | | | |
| prestressed | | | | |
| 5. Soda lime-silicate | Aqueous potassium- | 58 | 116 | 115 |
| glass | phosphate solution | | | |
| with functional layers | pH 10.5; 2 min @ 50° C. | | | |
| not prestressed | aqueous citric acid | | | |
| | solution | | | |
| | pH 2.5; 2 min@ 40° C. | | | |
| | Deionized water | | | |
| | 0.5 min@ 20° C. | | | |
| 6. Aluminosilicate glass | Aqueous potassium- | 58 | 118 | 116 |
| with functional layers | phosphate solution | | | |
| not prestressed | pH 10.5; 2 min @ 50° C. | | | |
| | aqueous citric acid | | | |
| | solution | | | |
| | pH 2.5; 2 min@ 40° C. | | | |
| | Deionized water | | | |
| | 0.5 min@ 20° C. | | | |
| 7. Soda lime-silicate | Aqueous potassium- | 58 | 115 | 115 |
| glass | phosphate solution | | | |
| with functional layers | pH 10.5; 2 min @ 50° C. | | | |
| prestressed | aqueous citric acid | | | |
| | solution | | | |
| | pH 2.5; 2 min@ 40° C. | | | |
| | Deionized water | | | |
| | 0.5 min@ 20° C. | | | |
| 8. Aluminosilicate glass | Aqueous potassium- | 56 | 117 | 116 |
| with functional layers | phosphate solution | | | |
| prestressed | pH 10.5; 2 min @ 50° C. | | | |
| | aqueous-citric acid | | | |
| | solution | | | |
| | pH 2.5; 2 min@ 40° C. | | | |
| | Deionized water | | | |
| | 0.5 min@ 20° C. | | | |
| 9. Soda lime-silicate | Deionized water | 58 | 115 | 110 |
| glass | 30 min @ 60° C. | | | |
| with functional layers | | | | |
| prestressed | | | | |
| 10. Aluminosilicate | Deionized water | 58 | 115 | 113 |
| glass | 30 min @ 60° C. | | | |
| with functional layers | | | | |
| prestressed | | | | |
| 11. Soda lime-silicate | Ultrasound cleaning: 30-40 kHz | 60 | 116 | 113 |
| glass with | aqueous sodium | | | |
| functional layers | hydroxide solution | | | |
| not prestressed | pH 10.8; 10 min @ 60° C. | | | |
| | Deionized water | | | |
| | 2 min@ 20° C. | | | |
| 12. Aluminosilicate | Ultrasound cleaning: 30-40 kHz | 60 | 117 | 116 |
| glass | aqueous sodium | | | |
| with functional layers | hydroxide solution | | | |
| prestressed | pH 10.8; 10 min @ 60° C. | | | |
| | Deionized water | | | |
| | 2 min@ 20° C. | | | |

In table 1:
Glasses # 1 and 2 did not have functional layer, were not activated, but are prestressed.
Glasses # 3 and 4 have functional layers, were not activated, but are prestressed.
Glasses # 5 and 6 have functional layers, were activated, but are not prestressed.
Glasses # 7 to 12 have functional layers, were activated and are prestressed, i.e., are glass substrates produced according to the present invention.

In the examples, the antireflective coating and the anti-fingerprint coating applied thereupon are simply referred to as “functional layers”.

Above table 1 illustrates that the glass substrates produced according to the present invention (#7 to 12) show practically no change in the contact angle after 504 hours test time, whereas the glass substrates that are not produced according to the present invention (#1 to 4) have clear changes in the contact angle. Glass substrates #5 and 6, which are not produced according to the present invention, are not chemically prestressed and are therefore not scratch resistant and break resistant to the desired extent. The contact angle serves as a measure of whether or not the properties can be maintained following a stress test in the form of the neutral salt spray test. The NSS test is known to be one of the most critical tests for such stresses. It reflects the stresses that occur, for example, during touching with fingerprints. The salt content of the finger sweat is a typical influence for layer failure. The long-term durability is a crucial characteristic for this.

As demonstrated by the consistent contact angle, as determined within the scope of the measurement accuracy, the activation process according to the present invention provides the glass substrates with a clear improvement of the long-term durability that are not obtained with known glass substrates.

With the above glass substrates, the values for the compressive stress (CS) and the depth of penetration (DoL) were moreover determined with measuring device FSM6000 based on the optical properties of the glass plates. The CS- and DoL value were measured for 5 samples and the average value was used. In table 2 below, the values are stated and a comparison regarding the visual degree of reflection pvA is given.

TABLE 2

| | CS [MPa] | CS [MPa] | DoL [μm] | | DoL [μm] | | R [%] | R [%] |
|---|---|---|---|---|---|---|---|---|
| | Before | After | Before | | After | | Before | After |
| Glass # | activation | activation | activation | | activation | | activation | activation |
| 7 | 432 (+/−4) | 438 (+/−6) | 12.2 | (+/−0.9) | 12.1 | (+/−0.7) | 0.73 | 0.72 |
| 8 | 755 (+/−8) | 754 (+/−6) | 35 | (+/−2.1) | 35 | (+/−1.1) | 0.76 | 0.75 |
| 9 | 444 (+/−6) | 443 (+/−8) | 11.9 | (+/−0.5) | 12.0 | (+/−0.6) | 0.69 | 0.65 |
| 10 | 751 (+/−6) | 749 (+/−8) | 33 | (+/−1.1) | 33 | (+/−0.7) | 0.81 | 0.80 |
| 11 | 439 (+/−3) | 441 (+/−4) | 12.2 | (+/−0.9) | 12.1 | (+/−0.7) | 0.71 | 0.72 |
| 12 | 750 (+/−2) | 753 (+/−6) | 36 | (+/−1.7) | 36 | (+/−1.1) | 0.79 | 0.78 |

The values in Table 2 demonstrate that chemical prestressing, characterized by the compressive stress (CS) and the depth of penetration (DoL), is not being negatively influenced by the activation process; the beneficial properties of the glass substrates remain intact. The values of the degree of reflection before and after activation moreover show that also the beneficial optical properties were not negatively affected by the activation process.

The present invention therefore provides a coated glass substrate within a unique combination of properties.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a coated, chemically prestressed glass substrate having anti-fingerprint properties, comprising:
applying at least one functional layer onto a glass substrate to form a coated glass substrate;
chemically pre-stressing said coated glass substrate by an ion exchange, wherein existing smaller alkali metal ions are exchanged for larger alkali metal ions and are enriched in said glass substrate and said at least one functional layer;
activating a surface of said at least one functional layer, wherein if said at least one functional layer comprises a plurality of functional layers a surface of an outermost or uppermost layer is activated, wherein said activating comprises one of the following alternatives:
1) treating said surface of said at least one functional layer with an alkaline aqueous solution and subsequent washing with water;
2) treating said surface of said at least one functional layer with an acidic aqueous solution and subsequent washing with water;
3) treating said surface of said at least one functional layer with an alkaline aqueous solution and subsequent washing with water, treating said surface of said at least one functional layer with an acidic aqueous solution following said treatment with said alkaline aqueous solution and subsequent washing with water;
4) washing said surface of said at least one functional layer with an aqueous washing solution containing at least one tenside and subsequent rinsing with water;
5) washing said surface of said at least one functional layer with water;
6) one of alternatives 1, 2, 3, and 4 combined with ultrasonic cleaning;
7) treating said surface of said at least one functional layer with oxygen-plasma; and
8) one of alternatives 1, 2, 3, 4, 5, and 6 combined with oxygen-plasma treatment; and
applying an amphiphobic coating onto said at least one functional layer of said glass substrate, whereby said at least one functional layer interacts with said amphiphobic coating as a result of said activating.

2. The method according to claim 1, wherein said alkaline aqueous solution has a pH value above 9 and contains at least one of sodium and potassium ions.

3. The method according to claim 1, wherein at least one of said treating steps comprises at least one of spreading, infusion, spraying, and dipping said coated glass substrate in said respective solution for a defined time period at a temperature between 20° C. and a boiling point of said respective solution.

4. The method according to claim 1, wherein said acidic aqueous solutions includes at least one of an inorganic acid and an organic acid.

5. The method according to claim 1, wherein said at least one functional layer comprises an inorganic layer defining at least one of an optically effective layer, an antireflective layer, an antiglare layer, an antidazzle layer, an anti-scratch layer, a conductive layer, a cover layer, an adhesion promoting layer, a protective layer, an abrasion resistant layer, a photocatalytic layer, an antimicrobial layer, a decorate layer, a colored layer, and an electrochromic layer.

6. The method according to claim 1, wherein said chemical pre-stressing comprises one of:
dipping said coated glass substrate in a substance containing at least one of potassium, rubidium, and cesium;
vapor deposition; and
temperature-activated diffusion.

7. The method according to claim 6, wherein said chemical pre-stressing comprises dipping said coated glass substrate into a solution containing antimicrobially effective ions and at least one of potassium, rubidium, and cesium.

8. The method according to claim 1, wherein said at least one functional layer one of comprises and consists of an Si-compound, wherein if said at least one functional layer comprises a plurality of functional layers then an outermost or uppermost layer one of comprises and consists of an Si-compound.

9. The method according to claim 8, wherein said Si-compound comprises at least one of:
a silicon oxide;
SiOₓ with x being less than or equal to 2;
SiOC;
SiON;
SiOCN;
Si₃N₄;
SiOₓ combined with a volume of hydrogen, wherein x is less than or equal to 2; and
a silicon mixed oxide including a mixture of one silicon oxide with one oxide of at least one of aluminum, tin, magnesium, phosphorus, cerium, zircon, titanium, cesium, barium, strontium, niobium, zinc, boron and magnesium fluoride.

10. The method according to claim 1, wherein said at least one functional layer is applied at a thickness of greater than 1 nm.

11. The method according to claim 1, wherein said at least one functional layer comprises an antireflective coating.

12. The method according to claim 11, wherein said antireflective coating consists of a single layer comprising at least one of a metal oxide, a fluorine doped metal oxide, a metal fluoride, a silicon-oxide, a fluorine doped SiO₂, a fluorine doped quartz glass, a magnesium fluoride silicon oxide, and a silicon mixed oxide.

13. The method according to claim 11, wherein said antireflective coating comprises a plurality of layers, wherein said plurality of layers alternate one of:
high refractive layers and low refractive layers; and
medium refractive layers, high refractive layers, and low refractive layers.

14. The method according to claim 13, wherein each of said plurality of layers comprises or consists of at least one of titanium oxide, niobium oxide, tantalum oxide, cerium oxide, hafnium oxide, silicon oxide, magnesium fluoride, aluminum oxide, zircon oxide, yttrium oxide, gadolinium oxide, and silicon nitrate, said antireflective coating having a thickness of 50 nm to 100 μm.

15. The method according to claim 1, further comprising drying said coated glass substrate after said activating.

16. The method according to claim 1, wherein said glass substrate is a lithium aluminum silicon glass comprising the following in weight-%:

| | |
|---|---|
| SiO₂ | 55-69; |
| Al₂O₃ | 19-25; |
| Li₂O | 3-5; |
| Sum Na₂O + K₂O | 0-30; |
| Sum MgO + CaO + SrO + BaO | 0-5; |
| ZnO | 0-4; |
| TiO₂ | 0-5; |
| ZrO₂ | 0-3; |
| Sum TiO₂ + ZrO₂ + SnO₂ | 2-6; |
| P₂O₅ | 0-8; |
| F | 0-1; and |
| B₂O₃ | 0-2. |

17. The method according to claim 1, wherein said glass substrate is a soda lime-silicon glass comprising the following in weight-%:

| | |
|---|---|
| SiO₂ | 40-80; |
| Al₂O₃ | 0-6; |
| B₂O₃ | 0-5; |
| Sum Li₂O + Na₂O + K₂O | 5-30; |
| Sum MgO + CaO + SrO + BaO + ZnO | 5-30; |
| Sum TiO₂ + ZrO₂ | 0-7; and |
| P₂O₅ | 0-2. |

18. The method according to claim 1, wherein said glass substrate is a borosilicate glass comprising the following in weight-%:

| | |
|---|---|
| SiO₂ | 60-85; |
| Al₂O₃ | 1-10; |
| B₂O₃ | 5-20; |
| Sum Li₂O + Na₂O + K₂O | 2-16; |
| Sum MgO + CaO + SrO + BaO + ZnO | 0-15; |
| Sum TiO₂ + ZrO₂ | 0-5; and |
| P₂O₅ | 0-2. |

19. The method according to claim 1, wherein said glass substrate is an alkali-aluminosilicate glass comprising the following in weight-%:

| | |
|---|---|
| SiO₂ | 40-75; |
| Al₂O₃ | 10-30; |
| B₂O₃ | 0-20; |
| Sum Li₂O + Na₂O + K₂O | 4-30; |
| Sum MgO + CaO + SrO + BaO + ZnO | 0-15; |
| Sum TiO₂ + ZrO₂ | 0-15; and |
| P₂O₅ | 0-10. |

20. The method according to claim 1, wherein said glass substrate is a low alkali-aluminosilicate glass comprising the following in weight-%:

| | |
|---|---|
| SiO₂ | 50-75; |
| Al₂O₃ | 7-25; |
| B₂O₃ | 0-20; |
| Sum Li₂O + Na₂O + K₂O | 1-4; |
| Sum MgO + CaO + SrO + BaO + ZnO | 5-25; |
| Sum TiO₂ + ZrO₂ | 0-10; and |
| P₂O₅ | 0-5. |

21. The method according to claim 1, wherein said glass substrate is a siliceous glass comprising the following in weight-%:

| | |
|---|---|
| SiO₂ | 10-90; |
| Al₂O₃ | 0-40; |
| B₂O₃ | 0-80; |
| Na₂O | 1-30; |
| K₂O | 0-30; |
| CoO | 0-20; |
| NiO | 0-20; |
| Ni₂O₃ | 0-20; |
| MnO | 0-20; |
| CaO | 0-40; |
| BaO | 0-60; |
| ZnO | 0-40; |
| ZrO₂ | 0-10; |
| MnO₂ | 0-10; |
| CeO | 0-3; |
| SnO₂ | 0-2; |
| Sb₂O₃ | 0-2; |
| TiO₂ | 0-40; |
| P₂O₅ | 0-70; |
| MgO | 0-40; |
| SrO | 0-60; |
| Li₂O | 0-30; |
| Li₂O + Na₂O + K₂O | 1-30; |
| SiO₂ + B₂O₃ + P₂O₅ | 10-90; |
| Nd₂O₅ | 0-20; |
| V₂O₅ | 0-50; |
| Bi₂O₃ | 0-50; |
| SO₃ | 0-50; and |
| SnO | 0-70, |

wherein the content of SiO₂+P₂O₅+B₂O₃ is 10-90 weight-%.

22. The method according to claim 1, wherein said glass substrate is a lead glass comprising the following in weight-%:

| | |
|---|---|
| PbO | 20-80; |
| SiO₂ | 20-60; |
| K₂O | 0-10; |
| Na₂O | 1-10; |
| BaO | 0-20; |
| SrO | 0-20; |
| Al₂O₃ | 0-10; |
| CaO | 0-10; |
| F₂O₃ | 0-1; |
| Sb₂O₃ | 0-1; |
| ZnO | 0-20; |
| B₂O₃ | 0-20; and |
| ZrO₂ | 0-10. |

23. The method according to claim 1, wherein said glass substrate comprises at least one of a colored oxide, a rare earth oxide, and a refining agent.

24. The method according to claim 1, wherein said glass substrate is one of a glass ceramic and a ceramized glass of a starting glass comprising the following in weight-%:

| | |
|---|---|
| Li₂O | 3.2-5.0; |
| Na₂O | 0-1.5; |
| K₂O | 0-1.5; |
| Sum Na₂O + K₂O | 0.2-2.0; |
| MgO | 0.1-2.2; |
| CaO | 0-1.5; |
| SrO | 0-1.5; |
| BaO | 0-2.5; |
| ZnO | 0-1.5; |
| Al₂O₃ | 19-25; |
| SiO₂ | 55-69; |
| TiO₂ | 1.0-5.0; |
| ZrO₂ | 1.0-2.5; |
| SnO₂ | 0-1.0; |
| Sum TiO₂ + ZrO₂ + SnO₂ | 2.5-5.0; and |
| P₂O₅ | 0-3.0 |

25. The method according to claim 1, wherein said glass substrate is one of a glass ceramic and a ceramizable glass of a starting glass comprising the following in weight-%:

| | |
|---|---|
| Li₂O | 3-5; |
| Na₂O | 0-1.5; |
| K₂O | 0-1.5; |
| Sum Na₂O + K₂O | 0.2-2; |
| MgO | 0.1-2.5; |
| CaO | 0-2; |
| SrO | 0-2; |
| BaO | 0-3; |
| ZnO | 0-1.5; |
| Al₂O₃ | 15-25; |
| SiO₂ | 50-75; |
| TiO₂ | 1-5; |
| ZrO₂ | 1-2.5; |
| SnO₂ | 0-1.0; |
| Sum TiO₂ + ZrO₂ + SnO₂ | 2.5-5; and |
| P₂O₅ | 0-3.0. |

26. The method according to claim 1, wherein said glass substrate is one of a glass ceramic and a ceramizable glass of a starting glass comprising the following in weight-%:

| | |
|---|---|
| Li₂O | 3-4.5; |
| Na₂O | 0-1.5; |
| K₂O | 0-1.5; |
| Sum Na₂O + K₂O | 02.-2; |
| MgO | 0-2; |
| CaO | 0-1.5; |
| SrO | 0-1.5; |
| BaO | 0-2.5; |
| ZnO | 0-2.5; |
| B₂O₃ | 0-1; |
| Al₂O₃ | 19-25; |
| SiO₂ | 55-69; |
| TiO₂ | 1.4-2.7; |
| ZrO₂ | 1.3-2.5; |
| SnO₂ | 0-0.4; |
| Sum TiO₂ + SnO₂ | less than 2.7; |
| P₂O₅ | 0-3; and |
| Sum ZrO₂ + 0.87 (TiO₂ + SnO₂) | 3.6-4.3. |

27. The method according to claim 1, wherein said glass substrate is a glass ceramic containing one of high quartz mixed crystals and keatite mixed crystals as the predominant crystals phase, wherein a crystal size of said crystals is less than 70 nm.

28. The method according to claim 1, wherein said amphiphobic coating includes at least one layer comprising at least one of a layer on a fluorine basis, a fluororganic compound, a perfluorohydrocarbon, a perfluoropolyether, at least one silane, an alkyl-containing silane, and a fluoroalkyl-containing silane.

29. The method according to claim 1, wherein one of a textured layer and a patterned layer is located between said at least one functional layer and said glass substrate, wherein said one of a textured layer and a patterned layer has a roughness in the range of 5 nm to 5 μm.

30. A coated, chemically prestressed glass substrate, produced according to the method of claim 1.
